(19) United States
(12) Patent Application Publication
(10) Pub. No.: US 2022/0207825 A1
(43) Pub. Date: Jun. 30, 2022

(54) MACHINE VISION-BASED TREE RECOGNITION METHOD AND DEVICE

(71) Applicant: SZ DJI TECHNOLOGY CO., LTD., Shenzhen (CN)

(72) Inventors: Chuangjie REN, Shenzhen (CN); Xinchao LI, Shenzhen (CN); Sijin LI, Shenzhen (CN); Jiabin LIANG, Shenzhen (CN); Yi TIAN, Shenzhen (CN)

(73) Assignee: SZ DJI TECHNOLOGY CO., LTD., Shenzhen (CN)

(21) Appl. No.: 17/695,830

(22) Filed: Mar. 16, 2022

Related U.S. Application Data
(63) Continuation of application No. PCT/CN2019/106161, filed on Sep. 17, 2019.

(51) Int. Cl. G06T 17/05; G06V 10/82; G06V 10/46; G06V 10/48

(52) U.S. Cl. CPC G06T 17/05; G06V 10/48; G06V 10/476; G06V 10/82

(57) ABSTRACT

A machine vision-based tree recognition method and device are provided. The machine vision-based tree recognition method may include obtaining a top view image containing a tree and processing the top view image to obtain pixel position information of a tree center of the tree and tree radius information corresponding to the tree center in the top view image.

### CROSS-REFERENCE TO RELATED APPLICATION

The present application is a continuation of International Application No. PCT/CN2019/106161, filed Sep. 17, 2019, the entire contents of which being incorporated herein by reference in its entirety.

### TECHNICAL FIELD

The present disclosure relates to the technical field of machine vision, and particularly relates to a machine vision-based tree recognition method and device.

### BACKGROUND

With continuous development of agricultural automation, there is a scenario where it is necessary to know a center position of a tree contained in an area, i.e., a position of a tree center. In the existing technology, a manual recognition method is usually used to obtain a position of a tree center. Specifically, a surveyor may use a measuring device to perform field measurement on a tree contained in an area to obtain manual measurement results and determine position information of a tree center of the tree in the area according to the manual measurement results.

### SUMMARY

The present disclosure provides a machine vision-based tree recognition method and device, which are used to solve the problems of high labor cost and low recognition efficiency in determining the position of a tree center based on the manual recognition method in the exciting technology.

According to a first aspect of the present disclosure, a machine vision-based tree recognition method is provided. The machine vision-based tree recognition method may include:

acquiring a top view image containing a tree; and

processing the top view image to obtain pixel position information of a tree center of the tree and tree radius information corresponding to the tree center in the top view image.

According to a second aspect of the present disclosure, a machine vision-based tree recognition method is provided, the machine vision-based tree recognition method may include:

acquiring a top view image containing a tree; and

processing the top view image to obtain tree information in the top view image, where the tree information includes pixel position information of a tree center of the tree.

According to a third aspect of the present disclosure, a machine vision-based tree recognition device is provided. The machine vision-based tree recognition device may include a processor and a memory, the memory configured to store program codes, the processor configured to call the program codes and_{;} when the program codes are executed, configured to:

acquire a top view image containing a tree; and process the top view image to obtain pixel position information of a tree center and tree radius information corresponding to the tree center of the tree in the top view image.

According to a fourth aspect of the present disclosure, a machine vision-based tree recognition device is provided. The machine vision-based tree recognition device may include a processor and a memory, the memory configured to store program codes, the processor configured to call the program codes and, when the program codes are executed, configured to:

acquire a top view image containing a tree; and

process the top view image to obtain tree information in the top view image, where the tree information includes pixel position information of a tree center of the tree.

According to a fifth aspect of the present disclosure, a non-transitory computer-readable storage medium is provided. The computer-readable storage medium stores a computer program, the computer program includes at least one piece of code, the at least one piece of code may be executed by a computer to control the computer to execute any one of the methods described in the first aspect of the present disclosure.

According to a sixth aspect of the present disclosure, a non-transitory computer-readable storage medium is provided. The computer-readable storage medium stores a computer program, the computer program includes at least one piece of code, the at least one piece of code may be executed by a computer to control the computer to execute any one of the methods described in the second aspect of the present disclosure.

According to a seventh aspect of the present disclosure, a non-transitory computer program is provided. When executed by a computer, the computer program is used to implement any one of the methods described in the first aspect of the present disclosure.

According to an eighth aspect of the present disclosure, a non-transitory computer program is provided. When executed by a computer, the computer program is used to implement any one of the methods described in the second aspect of the present disclosure.

Therefore, some aspects of the present disclosure provide a machine vision-based tree recognition method and device. By processing a top view image containing a tree to obtain tree information in the top view image, where the tree information includes pixel position information of a tree center of the tree, the position of the tree center and the tree radius in the top view image may be automatically obtained based upon the top view image containing a tree. Compared with the method based on manual recognition to determine the position of a tree center, the labor cost is reduced, and the recognition efficiency is improved.

It should be understood that the above general description and the following detailed description are only exemplary and explanatory and are not restrictive of the present disclosure.

### BRIEF DESCRIPTION OF THE DRAWINGS

In order to explain the technical features of embodiments of the present disclosure more clearly, the drawings used in the present disclosure are briefly introduced as follow. Obviously, the drawings in the following description are some exemplary embodiments of the present disclosure. Ordinary person skilled in the art may obtain other drawings and features based on these disclosed drawings without inventive efforts.

FIG. 1 illustrates a schematic diagram of an application scenario of a machine vision-based tree recognition method according to some embodiments of the present disclosure.

FIG. 2 illustrates a schematic flowchart of a machine vision-based tree recognition method according to some embodiments of the present disclosure.

FIG. 3 illustrates a schematic flowchart of a machine vision-based tree recognition method according to some embodiments of the present disclosure.

FIG. 4 illustrates a schematic flowchart of a machine vision-based tree recognition method according to some embodiments of the present disclosure.

FIG. 5 illustrates a processing block diagram of a machine vision-based tree recognition method according to some embodiments of the present disclosure.

FIG. 6A-6D illustrate schematic diagrams of displaying tree information in a machine vision-based tree recognition method according to some embodiments of the present disclosure.

FIG. 7 illustrates a schematic structural diagram of a machine vision-based tree recognition device according to some embodiments of the present disclosure.

FIG. 8 illustrates a schematic structural diagram of a machine vision-based tree recognition device according to some embodiments of the present disclosure.

### DETAILED DESCRIPTION

The technical solutions and technical features encompassed in the exemplary embodiments of the present disclosure will be described in detail in conjunction with the accompanying drawings in the exemplary embodiments of the present disclosure. Apparently, the described exemplary embodiments are part of embodiments of the present disclosure, not all of the embodiments. Based on the embodiments and examples disclosed in the present disclosure, all other embodiments obtained by those of ordinary skill in the art without inventive efforts shall fall within the protection scope of the present disclosure.

Here, exemplary embodiments will be described in detail, and examples thereof are shown in the accompanying drawings. The implementation manners described in the following exemplary embodiments do not represent all implementation manners consistent with the present disclosure. On the contrary, they are only examples of devices and methods consistent with some aspects of the disclosure as detailed in the appended claims. Further, the chart(s) and diagram(s) shown in the drawings are only examples, and does not necessarily include all components, elements, contents and/or operations/steps, nor does it have to be arranged in the described or specific order. For example, certain steps of the method may be performed in other orders or at the same time; some components/elements can also be disassembled, combined or partially combined; therefore, the actual arrangement may be changed or modified according to actual conditions. In the case of no conflict, the components, elements, operations/steps and other features disclosed in the embodiments may be combined with each other.

The ethod based on manual recognition in the existing technology to determine the position of the tree center has problems of high labor cost and low recognition efficiency.

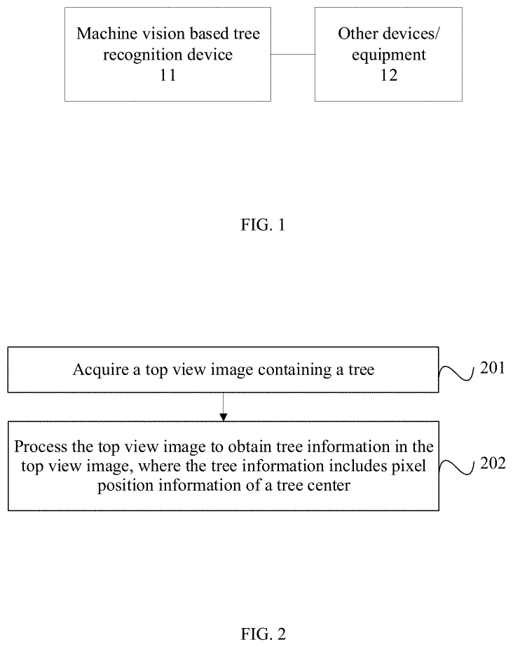

The machine vision-based tree recognition methods provided in the present disclosure may be applied to any scenario where the center position of a tree, i.e., the position of the tree center, needs to be recognized. The machine vision-based tree recognition method may be executed by a machine vision-based tree recognition device. FIG. 1 illustrates a schematic diagram of an application scenario of a machine vision-based tree recognition method according to some embodiments of the present disclosure. As shown in FIG. 1, a machine vision-based tree recognition device 11 may acquire a top view image containing a tree from another device/equipment 12 and process the acquired top view image using a machine vision-based tree recognition method provided in the present disclosure. The machine vision-based tree recognition device 11 may communicatively connected to another device/equipment 12. The specific method of communication connection between the machine vision-based tree recognition device 11 and another device/equipment 12 is not limited in the present disclosure. For example, a wireless communication connection may be realized based on, for example, a Bluetooth (IEEE 802.15.1) interface, a Wi-Fi (IEEE 802.11) interface, a mobile communication interface, a microwave communication interface, an infrared communication interface, or the like; or a wired communication connection may be realized based on, for example, an RS232 interface, an RS-422 interface, an RS-485 interface, an IO-link, ethernet, or the like.

It should be noted that the type of equipment that includes the machine vision-based tree recognition device may not be limited in the present disclosure. The equipment may be, for example, a desktop computer, an all-in-one computer, a notebook computer, a palmtop computer, a tablet computer, a smart phone, a remote control with a screen, or an unmanned aerial vehicle, etc.

It should be noted that, in FIG. 1, as an example, the machine vision-based tree recognition device acquires a top view image from another device or equipment. In some embodiments, the machine vision-based tree recognition device may acquire a top view image containing a tree in other ways. For example, the machine vision-based tree recognition device may generate the top view image.

The machine vision-based tree recognition methods provided in some embodiments of the present disclosure process the top view image containing the tree to obtain tree information in the top view image. The tree information includes pixel position information of a tree center. Therefore, the position of the tree center can be automatically obtained according to the top view image containing the trees. Compared with the method based on manual recognition to determine the position of a tree center, the machine vision-based tree recognition methods provided in some embodiments of the present disclosure reduce the labor cost and improve the recognition efficiency.

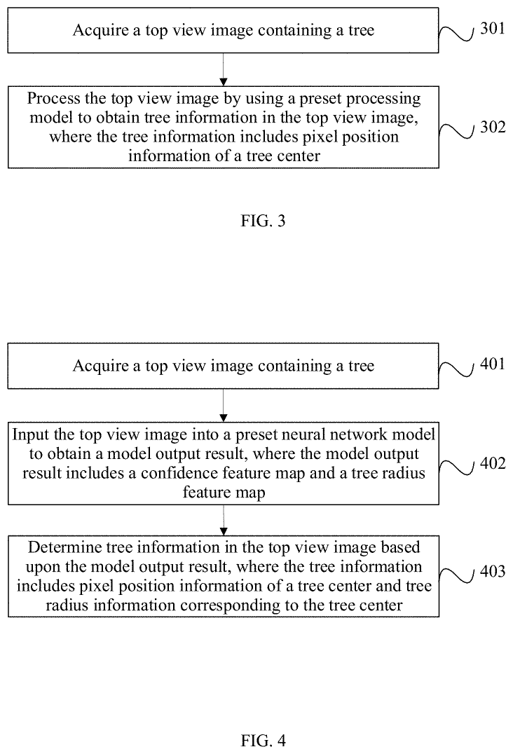

FIG. 2 illustrates a schematic flowchart of a machine vision-based tree recognition method according to some embodiments of the present disclosure. The machine vision-based tree recognition method may be executed by a machine vision-based tree recognition device, and specifically executed by a processor of the machine vision-based tree recognition device. As shown in FIG. 2, the machine vision-based tree recognition method may include step 201 and step 202:

In step 201, a top view image containing a tree is acquired.

The specific method for acquiring the top view image containing a tree may not be limited in the present disclosure. For example, in some embodiments, the top view image containing a tree may be acquired from another device/equipment.

It should be noted that the present disclosure does not limit the type of a tree. Exemplary a tree may be a fruit tree, such as a banana tree, an apple tree, and the like. The term “top view image containing a tree” used herein refers to an image containing a tree captured from a top view angle by a photographing device.

In step 202, the top view image is processed to obtain tree information in the top view image, where the tree information may include pixel position information of a tree center of the tree.

In some embodiments, for example, based upon the characteristics of the tree, the top view image may be processed to recognize the tree contained in the top view image so that the tree information may be obtained. The characteristics of the tree may include, for example, one or more of color, shape, height, or the like. The term “tree center” used herein refers to a center of a tree viewed from a top view angle in a top view image containing the tree.

Since the image is composed of pixels, some of the pixels may correspond to the tree, and some of the pixels may correspond to other objects, such as a building, ground, etc. Therefore, recognizing the position of the tree center may specifically recognize the pixel corresponding to the tree center in the image. In this way, the pixel position information of the tree center in the top view image is obtained.

Therefore, by processing the top view image containing a tree, the tree information in the top view image is obtained, where the tree information includes the pixel position information of the tree center. Thus, the position of the tree center is automatically obtained based upon the top view image containing the tree. Compared with the method based on manual recognition to determine the position of a tree center, the labor cost is reduced, and the recognition efficiency is improved.

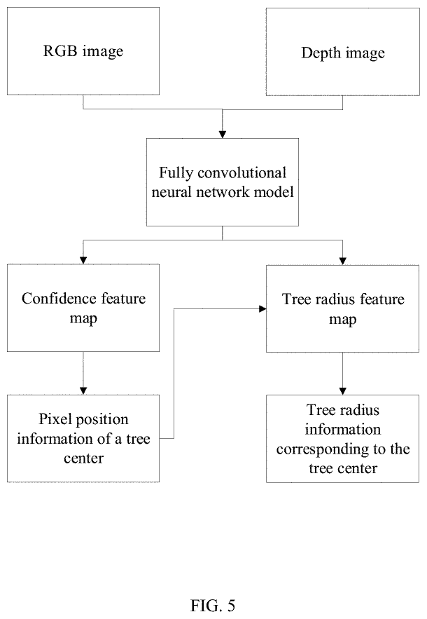

FIG. 3 illustrates a schematic flowchart of another machine vision-based tree recognition method according to some embodiments of the present disclosure. An exemplar implementation manner of processing the top view image on the basis of the disclosure shown in FIG. 2 is further described in detail. As shown in FIG. 3, the machine vision-based tree recognition method may include step 301 and step 302:

Step 301 may include acquiring a top view image containing a tree.

In the present disclosure, the top view image may be any type of image captured from a top view angle. In some embodiments, exemplarily, the top view image may include a Red-Green-Blue (RGB) image and/or a depth image.

In some embodiments, the top view image may be a digital orthophoto map (DOM). Step 301 may further include: utilizing a Digital Elevation Model (DEM) to generate a DOM containing a to-be-recognized region containing the tree, and the top view image may include the DOM. The to-be-recognized region may be understood as a region where the tree needs to be recognized. For example, a photographed image with a top view angle may be captured by a photographing device provided on an unmanned aerial vehicle. The photographed image may be processed by DEM to generate a DOM. It should be noted that the present disclosure does not limit the specific method of generating a DOM containing a to-be-recognized region containing a tree by using DEM.

Step 302 may include processing the top view image by using a preset processing model to obtain tree information in the top view image, where the tree information includes pixel position information of a tree center of the tree.

In some embodiments, for example, the preset processing model may be a preset neural network model. In certain embodiments, the preset neural network model may be a convolutional neural network model. In other embodiments, the preset neural network model may be a fully convolutional neural network model.

In certain embodiments, step 302 may include: inputting the top view image into a preset neural network model to obtain a model output result; and determining the tree information in the top view image based upon the model output result. The output of the preset neural network model may be an intermediate result for determining the tree information. The preset neural network model may be obtained by training with a sample image and a target result corresponding to the sample image.

It should be noted that the type of the top view image and the type of the sample image may be the same. In one embodiment, when the sample image includes an RGB image, the top view image may also include an RGB image. In another embodiment, when the sample image includes a depth image, the top view image may also include a depth image.

In certain embodiments, the target result may include a target confidence feature map. A pixel value of a pixel in the target confidence feature map represents a probability that the pixel is a tree center. For example, the pixel value of pixel 1 in the target confidence feature map is 0.5, which may represent the probability that pixel 1 is a tree center is 0.5. For another example, the pixel value of pixel 2 in the target confidence feature map is 0.8, which may represent the probability that pixel 2 is a tree center is 0.8. For another example, the pixel value of pixel 3 in the target confidence feature map is 1.1, which represents the probability that pixel 3 is a tree center is 1.

The size of the target confidence feature map and the size of the sample image input to the preset neural network model may be the same. For example, both are 150 pixel times 200 pixel images, that is, the pixels of the target confidence feature map may correspond to the pixels of the sample image input to the preset neural network model in one to one correspondence.

The target confidence feature map may be generated based upon a user tag and a probability generation algorithm. Specifically, the pixel corresponding to the position of a tree center in the sample image in the target confidence feature map (hereinafter referred to as the tree center pixel) can be determined based upon the user tag. The pixel value of each pixel in the target confidence feature map is further determined according to the probability generation algorithm.

In certain embodiments, the pixel value of each pixel in the target confidence feature map may be determined based upon a probability generation algorithm that the pixel value of a tree center pixel is 1, and the pixel value of a non-tree-center pixel is 0.

In certain embodiments, the pixel value of each pixel in the target confidence feature map may be determined based upon a probability generation algorithm that the pixel values centered on a tree center pixel satisfy a preset distribution. That is, the pixel values in the target confidence feature map are centered around the tree center pixel and satisfy the preset distribution.

The preset distribution is used to distinguish a region close to the tree center pixel and a region far away from the tree center pixel. Since pixels close to the tree center pixel have a small offset distance from the tree center pixel, when they are recognized as a tree center pixel, it will not deviate from the real tree center pixel too much. In contrast, pixels far away from the tree center pixel will have a large offset distance from the tree center pixel, and when they are recognized as the tree center pixel, a deviation from the real tree center pixel will be too large. Therefore, by distinguishing the regions close to and far away from the tree center pixel through the preset distribution, the pixels in the region close to the tree center pixel may be used as supplemental tree center pixels in the tree recognition process. As such, the preset neural network may have robustness. For example, even if the position of the real tree center is not successfully recognized, a position around the position of the real tree center can be recognized as the position of the tree center.

The preset distribution may be any type of distribution capable of distinguishing the region far away from the tree center pixel and the region close to the tree center pixel. In certain embodiments, considering that the closer the distance to the tree center pixel is, the smaller the error caused by being recognized as the tree center pixel is. Therefore, to improve the recognition accuracy of the preset neural network model, the preset distribution may be a distribution of a bell-shaped curve with high in the middle and low on both sides. For example, the preset distribution may include a circular Gaussian distribution or a quasi-circular Gaussian distribution.

In some embodiments, the parameters of the preset distribution may be set according to a preset strategy. The preset strategy includes that the region close to the tree center pixel satisfies at least one of the following conditions: being able to distinguish between two adjacent trees or maximizing the area of the region. Among them, through the preset strategy including that the region close to the tree center pixel satisfies the condition of being able to distinguish between two adjacent trees, the preset neural network may recognize adjacent trees, so as to improve the reliability of the preset neural network. Through the preset strategy including that the region close to the tree center pixel satisfies the condition of maximizing the area of the region, the robustness of the preset neural network may be improved as much as possible.

In some embodiments, a standard deviation of a circular Gaussian distribution may be set according to a preset strategy. For example, at beginning, a larger initial value may be used as the standard deviation of the circular Gaussian distribution. When the standard deviation is the initial value, two adjacent trees may be recognized as one tree, and then the value of the standard deviation may be reduced until the two adjacent trees are recognized as two trees instead of one tree, so as to determine the final value of the standard deviation of the circular Gaussian distribution.

When the target result of the preset neural network model includes a target confidence feature map, the model output result may include a confidence feature map. Accordingly, the obtaining the tree information based upon the model output result may include obtaining the pixel position information of the tree center based upon the confidence feature map.

The pixel value in the confidence feature map may represent a probability that the corresponding pixel is a tree center. Based upon a value of the probability that each pixel is a tree center, the pixel corresponding to the tree center in the confidence feature map can be identified. Since pixels in the confidence feature map correspond to pixels in the top view image, the pixel position information of the tree center in the top view image may be determined based upon the position information of the pixel corresponding to the tree center in the confidence feature map (i.e., pixel position information). In certain embodiments, the pixel position information corresponding to the tree center in the confidence feature map may be used as the pixel position information of the tree center in the top view image.

In some embodiments, the determining the pixel position information of the tree center in the top view image based upon the confidence feature map includes: performing a sliding window treatment on the confidence feature map by using a sliding window of a preset size to obtain a confidence feature map treated by the sliding-window. The sliding window treatment includes setting a non-maximum value in the window to a preset value, the preset value being less than a target threshold; and determining position information of a pixel whose pixel value in the confidence feature map treated by the sliding-window is greater than the target threshold as the pixel position information of the tree center in the top view image.

In some embodiments, a shape of the sliding window may be square or rectangular.

In some embodiments, the sliding window may be used to traverse the entire confidence feature map. It should be noted that the specific manner in which the sliding window traverses the entire confidence feature map may not be limited in the present disclosure. For example, the origin in the image coordinate system of the confidence feature map may be used as a starting point of the sliding window, the sliding window may first slide along the abscissa axis to an edge of the image, then slide one step along the ordinate axis, and then slide again along the abscissa axis to opposite edge of the image, etc. . . . , until the entire confidence feature map is traversed.

To avoid the problem that two adjacent trees are recognized as one tree due to the excessively large sliding window, which results in a poor recognition accuracy, the preset size may satisfy the condition that two adjacent trees can be distinguished, that is, the preset size cannot be too large. When the preset size is too small, the sliding window moves more times, thereby resulting the problem of a large amount of calculation. Therefore, the size of the sliding window can be set reasonably. For example, the preset size may be a 5 pixel times 5 pixel size.

The target threshold may be understood as a threshold for determining whether a pixel position corresponding to a pixel value is the position of the tree center. For example, the target threshold may be determined based upon value characteristics of pixel values in the confidence feature map. For example, the pixel value of a pixel near the position of the tree center is usually 0.7 or 0.8, thus, the target threshold may take a value of less than 0.7 or 0.8, for example, may be 0.3.

The non-maximum value in the window may be set to the preset value. Since the preset value is less than the target threshold, it can avoid recognizing one tree as multiple trees when the pixel values of a pixel corresponding to the position of the real tree center and other pixels near the pixel are large. That is, it can avoid recognizing multiple tree center positions for one tree. For ease of calculation, the preset value may be 0.

In some embodiments, before step 302, the method may further include: preprocessing the top view image to obtain a preprocessed top view image. Accordingly, step 302 may include: processing the preprocessed top view image through the preset processing model. In certain embodiments, the preprocessing may include a noise reduction processing, and noise in the original top view image may be removed by reducing the noise on the top view image. In certain embodiments, the preprocessing may include a down-sampling processing, and the down-sampling processing may reduce the amount of data and increase the processing speed.

Therefore, by processing the top view image containing a tree with the preset processing model to obtain tree information in the top view image, where the tree information includes the pixel position information of the tree center, the position of the tree center may be automatically obtained based upon the top view image containing the tree. Compared with the method based on manual recognition to determine the position of a tree center, it reduces the labor cost and improve the recognition efficiency.

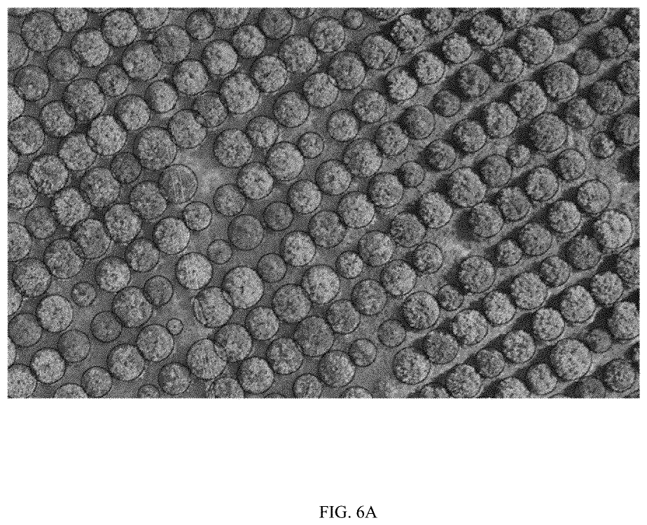

FIG. 4 illustrates a schematic flowchart of a machine vision-based tree recognition method according to some embodiments of the present disclosure. Based on the embodiments described above, the machine vision-based tree recognition method of FIG. 4 employs a preset neural network model as an exemplar preset processing model to describe an exemplar implementation method for recognizing a tree center of a tree and a tree crown radius of the tree. As shown in FIG. 4, the machine vision-based tree recognition method may include steps 401-403:

Step 401 may include acquiring a top view image containing a tree.

It should be noted that step 401 is similar to step 201 and step 301. For a detailed description of relevant contents, please refer to relevant parts of step 201 and step 301, which will not be repeated herein for conciseness.

Step 402 may include inputting the top view image into a preset neural network model to obtain a model output result, where the model output result includes a confidence feature map and a tree radius feature map.

In some embodiments, the preset neural network may be obtained by training based upon a sample image and a target result corresponding to the sample image, and the target result includes a target confidence feature map and a target tree radius feature map.

For the relevant description of the target confidence feature map, reference may be made to the embodiments shown in FIG. 3, which will not be repeated herein. The pixel value of a pixel corresponding to the tree center pixel in the target confidence feature map in the target tree radius feature map represents a tree crown radius viewed from a top view angle (it is referred to as a tree radius for short in the present disclosure). The sizes of the target tree radius feature map and the target confidence feature map may be the same, for example, both are 150 pixel times 200 pixel images. Therefore, the pixels of the target tree radius feature map may correspond to the pixels of the target confidence feature map in one-to-one correspondence. For example, the pixel with the coordinates (100, 100) in the target tree radius feature map may correspond to the pixel with the coordinates (100, 100) in the target confidence feature map. When the pixel with the coordinate (100, 100) in the target confidence feature map is a tree center pixel, the pixel value of the pixel with coordinates (100, 100) in the target tree radius feature map may represent the tree radius of the tree corresponding to the tree center pixel.

It should be noted that the pixel values of other pixels in the target tree radius feature map except those corresponding to the tree center pixels have no specific meaning. Therefore, the pixel values of those other pixels may not be concerned. For example, in certain embodiments, the pixel values of those other pixels may be set to 0.

Step 403 may include determining tree information in the top view image based upon the model output result, where the tree information includes pixel position information of a tree center and tree radius information corresponding to the tree center.

In some embodiments, step 403 may further include: obtaining the pixel position information of the tree center in the top view image based upon the confidence feature map; and obtaining the tree radius information corresponding to the tree center based upon the pixel position information of the tree center and the tree radius feature map. Among them, the relevant description about obtaining the pixel position information of the tree center based upon the confidence feature map may refer to the embodiments shown in FIG. 3, which will not be repeated herein for conciseness.

The pixels in the tree radius feature map correspond to the pixels in the confidence feature map in one to one correspondence, and the pixel value of a pixel in the tree radius feature map may represent tree radius information of the pixel corresponding to a pixel in the confidence feature map when the pixel in the confidence feature map is a tree center. Therefore, based upon the pixel corresponding to the tree center in the confidence feature map, the tree radius information of the tree center may be determined from the tree radius feature map.

In some embodiments, the determining the tree radius information of the tree based upon position information of the tree center and the tree radius feature map may include the following steps A and B.

Step A may include determining a target pixel corresponding to the position information of the tree center in the tree radius feature map based upon the position information of the tree center.

For example, assuming that two trees are recognized based upon the confidence feature map, which are recorded as tree 1 and tree 2, and the position information of the tree center of the tree 1 is the coordinate position (100, 200) in the confidence feature map, and the position information of the tree center of the tree 2 is the coordinate position (50, 100) in the confidence feature map. Then, the pixel at the coordinate position (100, 200) in the tree radius feature map corresponding to the confidence feature map may be used as the target pixel corresponding to the pixel position information of the tree 1. The pixel at the coordinate position (50, 100) in the tree radius feature map corresponding to the confidence feature map is used as the target pixel corresponding to the pixel position information of the tree 2.

Step B may include determining the tree radius information of the tree based upon a pixel value of the target pixel.

In some embodiments, when the pixel value in the tree radius feature map is equal to the tree radius information, the pixel value of the target pixel may be used as the tree radius information.

In some embodiments, to improve the processing speed of the preset neural network, the pixel values in the tree radius feature map may be normalized pixel values. For example, assuming that the maximum height of a tree is 160 meters, the pixel values in the tree radius feature map may be results normalized according to 160. Accordingly, the determining the tree radius information of the tree based upon the pixel value of the target pixel may include: denormalizing the pixel value of the target pixel to obtain the tree radius information of the tree. For example, assuming that the pixel value of the target pixel is 0.5, the tree radius information after denormalization may be 160×0.5=80 meters.

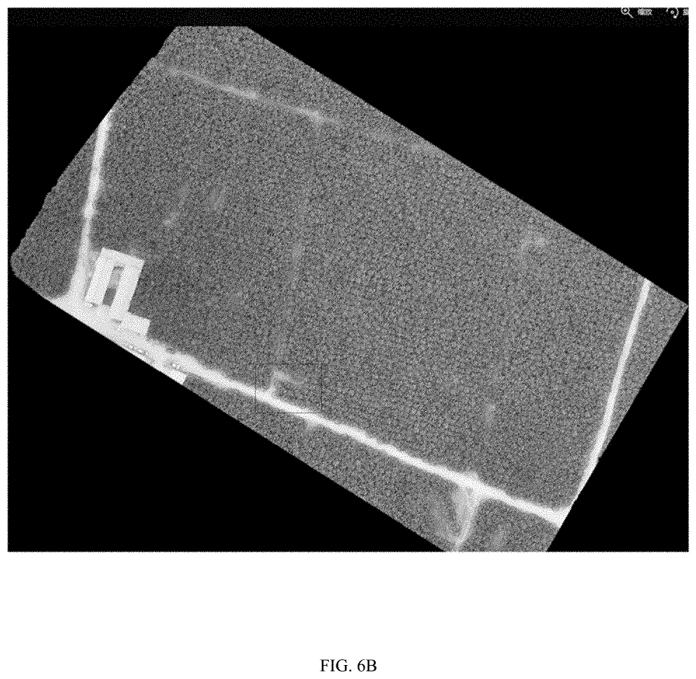

Taking the top view image including an RGB image and a depth image, and the preset neural network model as a fully convolutional neural network model as an example, the processing block diagram corresponding to step 401 to step 403 may be as shown in FIG. 5. FIG. 5 illustrates a processing block diagram of a machine vision-based tree recognition method according to some embodiments of the present disclosure. As shown in FIG. 5, the RGB image and the depth image may be input to the fully convolutional neural network model to obtain a confidence feature map and a tree radius feature map. Further, the pixel position information of a tree center may be determined based upon the confidence feature map, and the tree radius information of the tree center may be determined based upon the pixel position information of the tree center and the tree radius feature map.

Thus, by inputting the top view image into the preset neural network model, the output result of the preset neural network model is obtained. Based on the processing of the preset neural network, the semantics in the top view image are distinguished, and the probability that a pixel is a tree center (i.e., the confidence feature map) and the tree radius information when the pixel is the tree center (i.e., the tree radius feature map) are obtained. Further, the pixel position information of the tree center and the tree radius information corresponding to the tree center are obtained. The position of the tree center and the tree radius may be automatically obtained through the preset neural network model based upon the top view image containing a tree.

In some embodiments, to facilitate a user to view the tree information, based on the foregoing embodiments, the following step may be further included: displaying the tree information.

In certain embodiments, the tree information may be displayed by directly displaying information contents. For example, suppose that the top view image includes two trees, namely tree 1 and tree 2, and the pixel position information of the tree center of tree 1 is the position information of pixel A in the top view image and the tree radius information is 20 meters. The pixel position information of the tree center of tree 2 is the position information of pixel B in the top view image and the corresponding tree radius information is 10 meters. Then, the position coordinates of the pixel A in the coordinate system of the top view image and 20 meters, and the position coordinates of the pixel B in the coordinate system of the top view image and 10 meters may be directly displayed.

In certain embodiments, the tree information may be displayed by marking and displaying on the top view image. For example, suppose that the top view image includes two trees, namely tree 1 and tree 2, and the pixel position information of the tree center of tree 1 is the position information of pixel A, and the pixel position information of the tree center of tree 2 is the position information of pixel B. The corresponding positions of pixel A and pixel B may be marked in the top view image.

Compared with the direct display method, the marking and displaying method is more readable and convenient for users to know the position of the tree center.

In some embodiments, the displaying the tree information may include: marking the tree center in a target image according to the pixel position information of the tree center; obtaining a marked image; and displaying the marked image.

In some embodiments, the marking the tree center in the target image according to the pixel position information of the tree center may include marking a point of the tree center at a position corresponding to the pixel position information in the target image according to the pixel position information of the tree center.

When the tree information includes tree radius information corresponding to the tree center, the displaying of the tree information may further include: marking the tree center in the target image according to the pixel position information of the tree center; marking a tree radius in the target image according to the tree radius information corresponding to the tree center; and displaying the marked image.

In some embodiments, the marking the tree radius in the target image according to the tree radius information corresponding to the tree center may include, according to the pixel position information of the tree center and the tree radius information corresponding to the tree center, in the target image, marking a circle with a position corresponding to the pixel position information as the center of the circle, and a length corresponding to the tree radius information as the radius of the circle.

In certain embodiments, the target image may include one or more of an all-black image, an all-white image, or a top view image. The all-black image may be an image in which the R value, G value, and B value of each pixel are all 0, and the all-white image may be an image in which the R value, G value, and B value of each pixel are all 255.

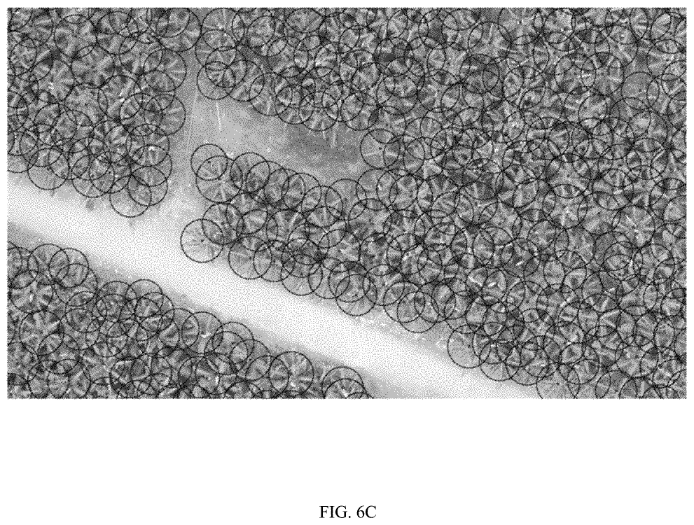

Taking the target image as a top view image as an example, the exemplar way of displaying pixel position information of a tree center and tree radius information corresponding to the tree center may be shown in FIG. 6A. FIG. 6A-6D illustrate schematic diagrams of displaying tree information in a machine vision-based tree recognition method according to some embodiments of the present disclosure. As shown in FIG. 6A, the points in FIG. 6A are the marked tree centers. The circles in FIG. 6A represent the marked tree radii.

Taking the target image as a top view image, and the displayed tree information including the position of a tree center and a tree radius as an example, the displayed marked image may be as shown in FIG. 6A. It can be seen from FIG. 6A that for a scenario where the tree centers are regularly distributed, the positions of the tree centers and the tree radii may be determined by the method provided in the present disclosure.

Taking the target image as a top view image, and the displayed tree information including the position of a tree center and a tree radius as an example, the displayed marked image may be as shown in FIGS. 6B-6C, where FIG. 6C is a schematic diagram for an enlarged display of a local region in the box in FIG. 6B. It can be seen from FIG. 6B and FIG. 6C that for a scenario where the tree center distribution is irregular, the positions of the tree centers and the tree radii may also be determined by the method provided in the present disclosure.

Taking the target image as an all-black image, and the displayed tree information including the position of a tree center as an example, corresponding to the top view image shown in FIG. 6B, the displayed marked image may be as shown in FIG. 6D.

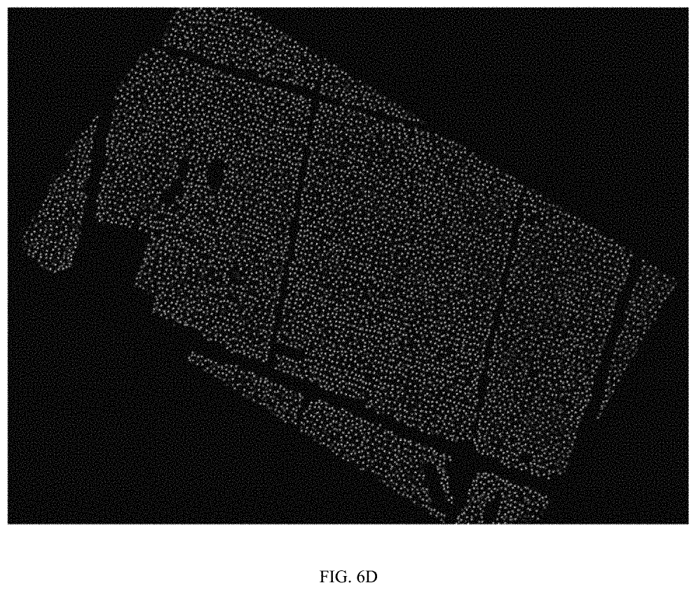

FIG. 7 illustrates a schematic structural diagram of a machine vision-based tree recognition device according to some embodiments of the present disclosure. As shown in FIG. 7, the machine vision-based tree recognition device 700 may include a memory 701 and a processor 702.

The memory 701 is configured to store program codes; and the processor 702 is configured to call the program codes, and, when the program codes are executed, configured to:

acquire a top view image containing a tree; and

process the top view image to obtain pixel position information of a tree center in the top view image and tree radius information corresponding to the tree center.

The machine vision-based tree recognition device provided above may be used to implement the technical schemes of obtaining tree information including position information of the tree center and tree radius information in the foregoing method embodiments. The implementation principles and technical effects are similar to those in the method embodiments described above and will not be repeated herein for conciseness.

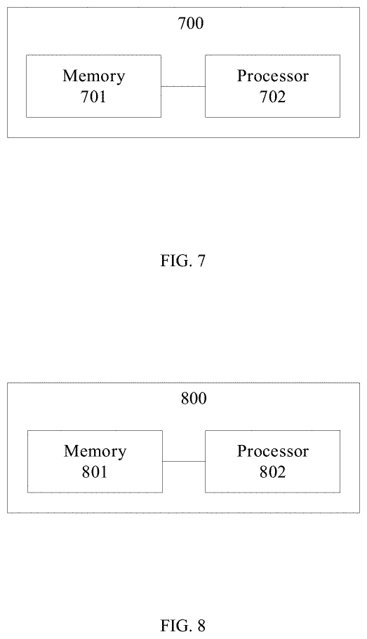

FIG. 8 illustrates a schematic structural diagram of another machine vision-based tree recognition device according to some embodiments of the present disclosure. As shown in FIG. 8, the machine vision-based tree recognition device 800 may include a memory 801 and a processor 802.

The memory 801 is configured to store program codes; and the processor 802 is configured to call the program codes, and, when the program codes are executed, configured to:

acquire a top view image containing a tree; and

process the top view image to obtain tree information in the top view image, the tree information including pixel position information of a tree center.

The machine vision-based tree recognition device provided above may be used to implement the technical schemes of the foregoing method embodiments. Its implementation principles and technical effects are similar to those in the method embodiments described above and will not be repeated herein for conciseness.

The present disclosure further provides a computer-readable storage medium. The computer-readable storage medium stores a computer program including at least one piece of code, the at least one piece of code may be executed by a computer to cause the computer to execute any one of the methods described above.

The present disclosure further provides a computer program. When executed by a computer, the computer program is configured to cause the computer to implement any one of the methods described above.

A person of ordinary skill in the art can understand that all or part of the steps in the foregoing method embodiments can also be implemented by a hardware related to program instructions. The computer program, program instructions, and/or program codes may be stored in a non-transitory computer readable storage medium. When the computer program, program instructions, and/or program codes are executed, the steps of the foregoing method embodiments are implemented.

The computer-readable storage medium may be an internal storage unit of the machine vision-based tree recognition device described in any of the foregoing embodiments, such as a hard disk or a memory of the machine vision-based tree recognition device. The computer-readable storage medium may also be an external storage device of the machine vision-based tree recognition device, such as a plug-in hard disk, a smart media card (SMC), and a secure digital (SD) card, a flash card, etc., equipped on the machine vision-based tree recognition device.

The computer readable storage medium may be a tangible device that can store programs and instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer program, program instructions, and program codes described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive the computer program, program instructions, and/or program code from the network and forward the computer readable program instructions for storage in a computer readable storage medium within the computing or processing device.

The computer program, program instructions and program codes for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer program, program instructions and/or program codes may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions and/or program codes by using information from the computer readable program instructions and/or program code to configure or customize the electronic circuitry, in order to perform aspects of the present disclosure.

The computer program, program instructions and program codes that may implement the device/systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer program, program instructions and program code also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer program, program instructions and program code may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer program, program instructions and/or program code.

The processor may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

The memory and non-volatile storage medium may be computer-readable storage media. The memory may include any suitable volatile storage devices such as dynamic random access memory (DRAM) and static random access memory (SRAM). The non-volatile storage medium may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

The program may be a collection of machine readable instructions and/or data that is stored in non-volatile storage medium and is used to create, manage, and control certain software functions that are discussed in detail elsewhere in the present disclosure and illustrated in the drawings. In some embodiments, the memory may be considerably faster than the non-volatile storage medium. In such embodiments, the program may be transferred from the non-volatile storage medium to the memory prior to execution by a processor.

Each part of the present disclosure may be implemented by hardware, software, firmware, or a combination thereof. In the above exemplary embodiments, multiple steps or methods may be implemented by hardware or software stored in a memory and executed by a suitable instruction execution system.

The terms used herein are only for the purpose of describing specific embodiments and are not intended to limit of the disclosure. As used in this disclosure and the appended claims, the singular forms “a,” “an,” and “the” are intended to include the plural forms as well, unless the context clearly indicates otherwise. It should also be understood that the term” and/or “as used herein refers to and encompasses any or all possible combinations of one or more associated listed items. Terms such as connected” or “linked” are not limited to physical or mechanical connections, and may include electrical connections, whether direct or indirect. Phrases such as “a plurality of,” “multiple,” or “several” mean two and more.

Finally, it should be noted that the above embodiments/examples are only used to illustrate the technical features of the present disclosure, not to limit them; although the present disclosure has been described in detail with reference to the foregoing embodiments and examples, those of ordinary skill in the art should understand that: the technical features disclosed in the foregoing embodiments and examples can still be modified, some or all of the technical features can be equivalently replaced, but, these modifications or replacements do not deviate from the spirit and scope of the disclosure.

What is claimed is:

1. A machine vision-based tree recognition method, comprising:
acquiring a top view image containing a tree; and
processing the top view image to obtain tree information in the top view image,
wherein the tree information comprises pixel position information of a tree center of the tree.

2. The machine vision-based tree recognition method of claim 1, wherein the processing the top view image comprises:
inputting the top view image into a preset neural network model to obtain a model output result of the preset neural network model; and
obtaining the tree information in the top view image based upon the model output result.

3. The machine vision-based tree recognition method of claim 2, wherein the preset neural network model is obtained by training based on a sample image and a target result corresponding to the sample image, the target result comprising a target confidence feature map; and
a pixel value of a pixel in the target confidence feature map represents a probability that the pixel is a tree center in the sample image.

4. The machine vision-based tree recognition method of claim 3, wherein pixel values in the target confidence feature map meet a preset distribution centered on a tree center pixel; and
the preset distribution is configured to distinguish a region close to the tree center pixel and a region far away from the tree center pixel,
wherein the tree center pixel is a pixel whose pixel position in the target confidence feature map corresponds to the tree center in the sample image.

5. The machine vision-based tree recognition method of claim 4, wherein the preset distribution comprises a circular Gaussian distribution or a quasi-circular Gaussian distribution.

6. The machine vision-based tree recognition method of claim 4, wherein parameters of the preset distribution are set based upon a preset strategy; and
the preset strategy includes that the region close to the tree center pixel satisfies at least one of being able to distinguish between two adjacent trees or maximizing an area of the region close to the tree center pixel.

7. The machine vision-based tree recognition method of claim 2, wherein the model output result comprises a confidence feature map corresponding to the top view image; and
the obtaining the pixel position information of the tree center in the top view image based upon the model output result comprises obtaining the pixel position information of the tree center in the top view image based upon the confidence feature map.

8. The machine vision-based tree recognition method of claim 7, wherein the obtaining the pixel position information of the tree center in the top view image based upon the confidence feature map comprises:
performing a sliding window treatment on the confidence feature map with a sliding window of a preset size to obtain a confidence feature map treated by the sliding-window, wherein the sliding window treatment comprises setting a non-maximum value in the window to a preset value, the preset value being less than a target threshold; and
setting position information of a pixel whose pixel value is greater than the target threshold in the confidence feature map treated by the sliding-window as the pixel position information of the tree center.

9. The machine vision-based tree recognition method of claim 8, wherein the preset size is configured to satisfy a condition that can distinguish two adjacent trees in the sliding window treatment.

10. The machine vision-based tree recognition method of claim 3, wherein the tree information further comprises tree radius information corresponding to the tree center;
the target result further comprises a target tree radius feature map; and
in the target tree radius feature map, a pixel value of a pixel corresponding to a tree center pixel in the target confidence feature map represents a tree crown radius, wherein the tree center pixel is a pixel in the target confidence feature map corresponding to a position of the tree center in the sample image.

11. The machine vision-based tree recognition method of claim 10, wherein the model output result comprises a confidence feature map and a tree radius feature map corresponding to the top view image; and the obtaining the tree information of the tree center based upon the model output result includes:
obtaining the pixel position information of the tree center in the top view image based upon the confidence feature map; and
obtaining the tree radius information corresponding to the tree center based upon the pixel position information of the tree center and the tree radius feature map.

12. The machine vision-based tree recognition method of claim 11, wherein the obtaining the tree radius information corresponding to the tree center based upon the pixel location information of the tree center and the tree radius feature map comprises:
determining a target pixel corresponding to the pixel position information in the tree radius feature map based upon the pixel position information of the tree center; and
obtaining the tree radius information corresponding to the tree center based upon a pixel value of the target pixel.

13. The machine vision-based tree recognition method of claim 12, wherein the obtaining the tree radius information corresponding to the tree center based upon the pixel value of the target pixel comprises:
denormalizing the pixel value of the target pixel to obtain the tree radius information corresponding to the tree center.

14. The machine vision-based tree recognition method of claim 1, wherein the acquiring the top view image containing the tree comprises utilizing a digital elevation model (DEM) to generate a digital orthophoto map (DOM) comprising a to-be-recognized region comprising the tree.

15. The machine vision-based tree recognition method of claim 1, further comprising:
marking the tree center in a target image based upon the pixel position information of the tree center to obtain a marked image and displaying the marked image.

16. The machine vision-based tree recognition method of claim 15, wherein the marking the tree center in the target image based upon the pixel position information of the tree center comprises, based upon the pixel position information of the tree center, marking a point of the tree center at a position corresponding to the pixel position information in the target image.

17. The machine vision-based tree recognition method of claim 15, wherein the tree information further comprises tree radius information corresponding to the tree center; and
the machine vision-based tree recognition method further comprises marking a tree radius in the target image based upon the tree radius information corresponding to the tree center.

18. The machine vision-based tree recognition method of claim 17, wherein the marking the tree radius in the target image based upon the tree radius information corresponding to the tree center comprises, based upon the pixel position information of the tree center and the tree radius information corresponding to the tree center, marking a circle with the position corresponding to the pixel position information as a center of the circle and a length corresponding to the tree radius information as a radius of the circle in the target image.

19. The machine vision-based tree recognition method of claim 1, wherein the machine vision-based tree recognition method is applied with an unmanned aerial vehicle.

20. A machine vision-based tree recognition device comprising a processor and a memory, the memory configured to store program codes, the processor configured to call the program codes, and, when the program codes are executed, configured to:
acquire a top view image containing a tree; and
process the top view image to obtain pixel position information of a tree center of the tree and tree radius information corresponding to the tree center in the top view image.
